(19) United States
(12) Patent Application Publication
(10) Pub. No.: US 2015/0073889 A1
(43) Pub. Date: Mar. 12, 2015

(54) Dynamic Retailer Rewards Based on Attributes of Historical Transactions and Calculated Values

(71) Applicant: Barclays PLC, London (GB)

(72) Inventor: Adam Griffiths, St Albans (GB)

(21) Appl. No.: 14/022,701

(22) Filed: Sep. 10, 2013

(51) Int. Cl. G06Q 30/02

(52) U.S. Cl. CPC G06Q 30/0224
USPC 705/14.25

(57) ABSTRACT

A system and method are described for providing dynamic retailer rewards. A database stores transaction data identifying attributes of a plurality of past purchases by a purchaser at a respective plurality of different retailers associated with one or more predefined retail sectors. An analytical engine calculates a customer value index (CVI) and a customer engagement index (CEI) for the purchaser based on attributes of the stored transaction data, the CVI indicative of a value of the purchaser to an identified retailer or retail sector based on the attributes of past purchases, and the CEI indicative of a level of engagement by the purchaser with the identified retailer or retail sector. A reward determiner calculates a dynamic reward for the purchaser based on the calculated CVI and CEI, the reward being redeemable by the purchaser against a purchase transaction at the identified retailer or a retailer of the identified retail sector.

### FIELD OF THE INVENTION

This invention relates to a virtual customer or purchaser loyalty rewards program, and more particularly to systems and methods for enabling retailers and merchants to dynamically target benefits and to reward customers based on historical behavior and calculated value.

### BACKGROUND OF THE INVENTION

Conventional loyalty rewards programs are structured marketing efforts that reward participating customers or purchasers and therefore encourage loyalty buying behavior with an associated merchant (retailer) or group or sector of merchants (retailers). In marketing generally and in retailing more specifically, a loyalty card, rewards card, points card, advantage card, or club card is a plastic, paper or electronic card that identifies the card holder as a registered member in a loyalty program. By presenting the card, the purchaser is typically entitled to one or more forms of benefit or reward, for example an applied discount on the current purchase, or an allotment of points that can be accumulated and exchanged for a reward against future purchases. Other loyalty rewards programs are structured such that participants are rewarded after they have performed the requisite transactions with the associated merchant/retailer, either in terms of number of transactions (e.g., purchase of goods or services from that merchant/retailer) or transaction amounts (e.g., a spend threshold for retail, credit or the like).

U.S. Patent Application Publication No. 2012/271699 discusses a system that allocates loyalty rewards to a customer in advance of the customer earning the reward based at least in part on historical purchasing performance. For example, the customer/participant is rewarded (e.g., provided rewards points or bestowed another reward) at the onset of a year based on the previous year's purchasing behavior/program participation, and as the customer/participant makes transactions throughout the ensuing year the purchases/transactions are decremented against the reward.

U.S. Patent Application Publication No. 2013/166367 discusses a system that rewards a purchaser for increasing their purchase volume with at least one participating merchant. The system offers an incentive for the purchaser to increase their purchase volume with the participating merchant. The system obtains a first set of electronic transactions between the purchaser and the participating merchant, determines a merchant baseline for the purchaser based on the first set of electronic transactions, obtains a second set of electronic transactions between the purchaser and the participating merchant, compares the second set of electronic transactions to the merchant baseline, and provides the reward to the purchaser based on the comparison.

What is desired is a system and method for enabling merchants/retailers to dynamically target benefits and to reward customers in a more efficient and flexible manner.

### SUMMARY OF THE INVENTION

According to one aspect of the present invention, a system is provided for providing dynamic retailer rewards. The system comprises a database storing transaction data identifying attributes of a plurality of purchases by a consumer at a respective plurality of different retailers and a first index calculator configured to calculate a customer value index (CVI) for the consumer or purchaser based on the stored transaction data. The CVI is indicative of a value of the consumer or purchaser to an identified retailer or retail sector based on the attributes of past purchases. A second index calculator is configured to calculate a customer engagement index (CEI) for the consumer or purchaser. The CEI is indicative of a level of engagement by the consumer with the identified retailer or retail sector. The system also includes a reward determiner configured to dynamically determine or calculate a reward for the purchaser based on the calculated CVI and CEI, the reward being redeemable by the purchaser for a purchase at the identified retailer.

In another aspect, the present invention provides a computer-implemented method for determining a dynamic reward for a purchaser. In accordance with the method, transaction data is stored identifying attributes of a plurality of past purchases by a purchaser at a respective plurality of different retailers associated with one or more predefined retail sectors. A customer value index (CVI) is calculated for the purchaser based on the stored transaction data, the CVI being indicative of a value of the purchaser to an identified retailer or retail sector based on the attributes of past purchases. A customer engagement index (CEI) is calculated for the purchaser. The CEI is indicative of a level of engagement by the purchaser with the identified retailer or retail sector. A dynamic reward is determined for the purchaser based on the calculated CVI and CEI, the reward being redeemable by the purchaser against a purchase transaction at the identified retailer or a retailer of the identified retail sector.

In other aspects, there is provided a computer program arranged to carry out the method when executed by suitable programmable devices, and a non-transitory storage medium comprising the computer program.

### BRIEF DESCRIPTION OF THE DRAWINGS

There now follows, by way of example only, a detailed description of embodiments of the present invention, with references to the figures identified below.

FIG. 1 is a block diagram showing the main components of a payment transaction processing system in a payment transaction environment, according to an embodiment of the invention;

FIG. 2 is a flow diagram illustrating the main processing steps performed by the system of FIG. 1 for a loyalty-based reward determination process according to an embodiment; and

FIG. 3 is a diagram of an example of a computer system on which one or more of the functions of the embodiment may be implemented.

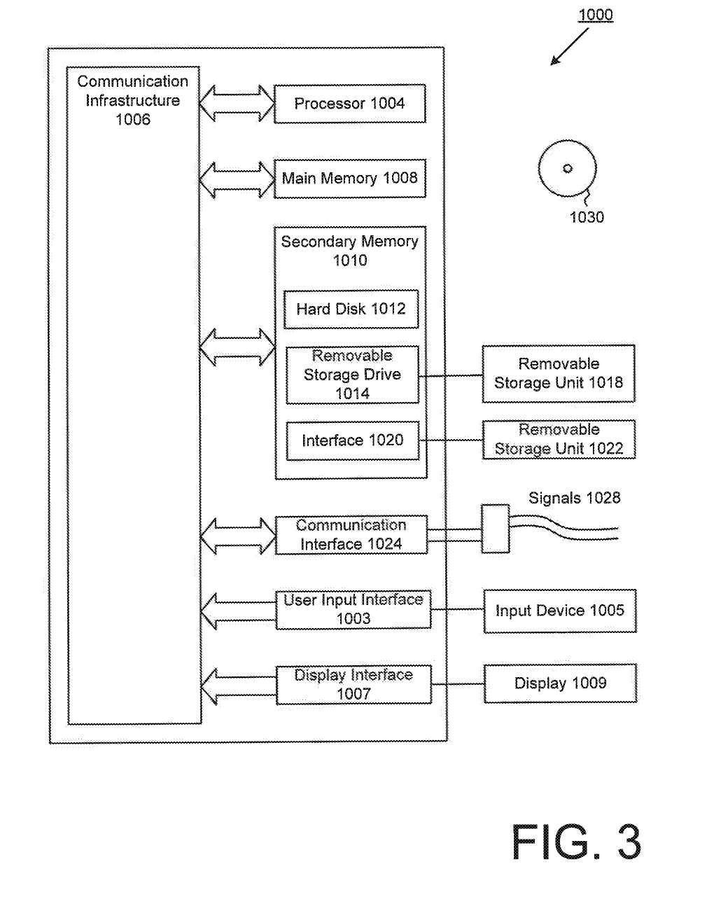

### DETAILED DESCRIPTION OF THE INVENTION

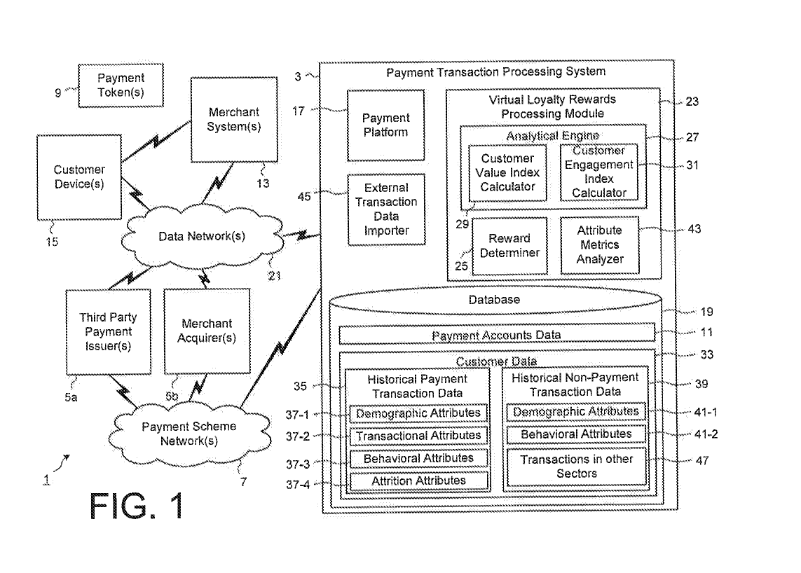

A specific embodiment of the invention will now be described for a process of dynamically determining loyalty rewards based on analyzed attributes of a purchaser's historical data. Referring to FIG. 1, a payment transaction environment 1 according to an embodiment comprises a payment transaction processing system 3 associated with a purchaser's payment account issuer. The system 3 facilitates the processing and completion of payment transactions between purchasers and merchants (retailers) for the purchase of goods or services. The payment transactions take place over any one of a number of channels (in a brick and mortar store or via the Internet, for example), and transaction settlement may involve routing of messages between components of the payment transaction environment 1, such as third party payment issuer(s) 5a and merchant acquirers 5b, via associated payment scheme networks 7, as typically provided in conventional card payment systems. For example, purchasers may pay for goods and services by presenting payment tokens 9, such as credit or debit cards associated with respective payment accounts 11 provided by the payment issuer, to a merchant system 13. As another example, the payment transaction may be initiated via purchaser devices 15 in electronic communication with respective interfaces, modules or components (not illustrated) of the merchant systems 13, such as a point of sale terminal and contactless/Near Field Communication (NFC) or conventional card reader, or a payment processing module of an online e-commerce website or hosted online payment service provider.

The payment transaction processing system 3 includes a payment platform 17 for processing payment transactions, for example, between registered payment accounts 11 stored in a database 19 of the payment transaction processing system 3 associated with respective registered users of the payment transaction processing system (who are purchasers of the associated payment issuer), or between a registered payment account 11 of the payment transaction processing system 3 and one or more external payment accounts provided by third party payment issuers 5a.

The purchaser devices 15 can be any suitable computing device for facilitating a payment transaction with the merchant systems 13, such as a mobile smartphone, tablet computer, personal computer, etc. that includes software and/or hardware components, such as a web browser and/or mobile wallet (not illustrated), to communicate with the merchant systems 13, via a direct communication path, such as a wired, a Bluetooth®, NFC, infrared data connection, or the like, or via one or more suitable data communication networks 21 such as a wireless network, a local- or wide-area network including a corporate intranet or the Internet, using for example the TCP/IP protocol, or a cellular communication network such as Global System for Mobile Communications (GSM), General Packet Radio Service (GPRS), Code Division Multiple Access (CDMA), CDMA2000. Enhanced Data Rates for GSM Evolution (EDGE), Evolved High-Speed Packet Access (HSPTA+), Long Term Evolution (LTE), etc.

As will be described below in greater detail, the payment transaction processing system 3 includes a virtual loyalty rewards processing module 23, hereinafter referred to as a rewards processing module, having a reward determiner module 25 that determines a personalized, loyalty-based reward (discount value/offer) from a scale of reward values for an identified purchaser and merchant, product/service, or retail sector (segment), from an initiated purchase transaction to be processed by the payment platform 17 or in response to a request for a reward, for example. The reward determiner module 25 communicates the personalized reward to the merchant system 13 and/or purchaser device 15, whereby the reward can be confirmed and applied to the purchase transaction.

The personalized reward is determined based on two factors determined by an analytical engine 27 of the reward processing module 23. The first factor determined by the analytical engine is a customer value index (CVI) determined by a CVI calculator module 29 of the analytical engine 27. The CVI defines a computed indication of current or predicted future monetary (commercial) value of the identified purchaser to the particular merchant or retail sector. The second factor is a customer engagement index (CEI) determined by a CEI calculator module 31 of the analytical engine 27. The CEI defines a computed indication of the purchaser's current or predicted future level of engagement with the particular merchant or retail sector. The CVI calculator module 29 and the CEI calculator module 31 determine the respective factors for an identified consumer based on one or more statistical prediction models that take into account attributes 37-1, 37-2, 37-3, 37-4 of the purchaser's historical payment transaction data 35 and/or attributes 41-1, 41-2, 47 of the purchaser's historical non-payment related transaction data 39.

The historical payment transaction attributes 37-1, 37-2, 37-3, 37-4 can be determined by an attribute metrics analyzer module 43 from stored purchaser data 33, including details of the purchaser's prior payment transactions from the purchaser's payment account(s) 11 for different products and services across a plurality of different merchants and associated retail sectors, as processed by the payment transaction processing system 3 and stored in the database 19. Each stored historical payment transaction may include data identifying details of the associated purchase, such as the associated merchant, purchased product(s) and/or service(s), value of the purchase(s), etc. The identified merchant can be associated with a predefined retail sector, and the transaction details may also include an indication of the associated retail sector. The predefined retail sectors may be based on one or more factors, such as the type of products/services provided by the associated merchants (such as clothing, travel, insurance, etc.), geographical location, commercial size, etc.

The purchaser's historical payment transaction data 35 may also include details of the purchaser's payment transactions with different merchants via third party payment issuers 5a, the details being received via an external transaction data importer module 45.

As illustrated in the exemplary embodiment of FIG. 1, the historical payment transaction attributes 37-1, 37-2, 37-3, 37-4 can include:
demographic attributes 37-1 indicative of demographics analyzed from the historical payment transaction data 35, such as geographical locations, etc.,
transactional attributes 37-2 indicative of financial/commercial statistics analyzed from the historical payment transaction data 35, such as accumulated spend at a particular merchant or across a retail sector, etc.,
behavioral attributes 37-3 indicative of consumer traits and behavioral variables analyzed from the historical payment transaction data 35, such as product/service purchase history, etc., and
attrition attributes 37-4 indicative of purchaser churn, purchaser turnover, or purchaser defection analyzed from the historical payment transaction data 35, such as a calculated loss of purchasers (e.g. to competitors) or any other business metric over a defined period of time, etc.

For example, the historical payment transaction data 35 can include details of a plurality of prior payment transactions by the purchaser at a plurality of different retailers, such as coffee shops. Based on the retrieved details of these prior payment transactions, the attribute metrics analyzer module 43 can determine a number of transaction attributes 37-2, such as total spend and frequency of payment transactions by the purchaser in a defined period of time (e.g. the past month) across the coffee shop retail sector.

The historical non-payment transaction data 39 can include details of non-payment transactions in other sectors 47. The historical non-payment transaction data 39 can also be determined by the attribute metrics analyzer module 43 from stored purchaser data 33, and include:
non-payment demographic attributes 41-1 indicative of demographics analyzed from the historical non-payment transaction data 39, such as gender, age, ethnicity, knowledge of languages, disabilities, mobility, home ownership, employment status, geographical locations, etc., and
non-payment behavioral attributes 41-2 indicative of behavioral trends analyzed from the historical non-payment transaction data 39.

The attribute metrics analyzer module 43 may also measure or estimate an amount/level of “dis-loyalty” of a purchaser to a particular merchant/retail sector, for example, by calculating and categorizing the potential value of moving a purchaser's projected expenditure from elsewhere (competitors), and estimating a top-up spend at the particular merchant or in the particular retail sector. Being able to identify such factors provide the reward processing module 23 with extra granularity to be able to personalize each purchaser experience.

### Determining Personalized Rewards

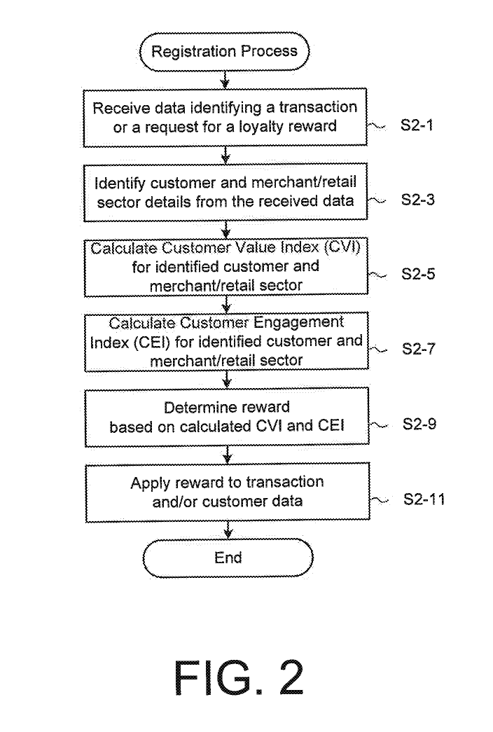

A brief description has been given above of the components forming part of the payment transaction processing system 3 of this embodiment. A more detailed description of the operation of these components in this embodiment will now be given with reference to the flow diagram of FIG. 2. An example is a computer-implemented dynamic loyalty rewards determination process, using the rewards processing module 23.

As shown in FIG. 2, the process begins at step S2-1 where the payment transaction processing system 3 receives data identifying a request for a loyalty-based reward that a purchaser or merchant wishes to apply to a payment transaction. Alternatively, the payment transaction processing system 3 may be configured to determine whether a loyalty reward is applicable for each payment transaction that is received and processed by the payment platform 17, whereby a request for a reward is generated by the payment platform 17 and transmitted to the rewards processing module 23. The request for a reward includes details of an associated purchaser, and an associated merchant or retail sector. At step S2-3, the rewards processing module 23 receives the request and identifies the purchaser and merchant/retail sector details from the received data. For example, the received request may be for a loyalty-based reward for an initiated payment transaction or a pending purchase transaction at a coffee shop, associated with a predefined coffee shop retail sector, and the rewards processing module 23 will respond, as described below, by determining a personalized reward (e.g. a pricing discount) for the purchaser that can be applied to the payment transaction, based on calculated current and predicted value and engagement factors of the purchaser to the coffee shop retail sector.

Accordingly, at step S2-5, the CVI calculator module 29 calculates a NI for the identified purchaser and merchant/retail sector, based on historical payment transaction data 35 and/or non-payment transaction data 39 associated with the identified purchaser, which may be determined by the attribute metrics analyzer module 43 from the purchaser's stored data 33. As mentioned above, the CVI calculator module 29 determines a CVI for an identified consumer based on one or more statistical prediction models that take into account one or more analyzed attributes 37-1, 37-2, 37-3, 37-4, 41-1, 41-2, 47 of the purchaser data 33. For example, the CVI calculator module 29 can determine a CVI as one of a low value index, a medium value index, or a high value index, using a prediction model that takes into account one or more of the retrieved attributes 37-1, 37-2, 37-3, 37-4, 41-1, 41-2, 47.

A CVI prediction model can be a combination of a “Revenue Forecasting” model (which might be retail sector or product specific) as well as factoring in frequency, demographics, and any other factors that are significant in a particular retail sector. A “Future Tenure” prediction model can be developed using “Survival” modeling techniques, where the tenure may be flexibly determined per retail sector, and may be calculated over predefined periods of time, in terms of months or years, for example.

At step S2-7, the CEI calculator module 31 calculates a CEI for the identified purchaser and merchant/retail sector, based on historical payment transaction data 35 and/or non-payment transaction data 39 associated with the identified purchaser. For example, the CEI calculator module 31 can determine a CEI as one of a low engagement index, a medium engagement index, or a high engagement index, using a prediction model that takes into account one or more of the retrieved attributes 37-1, 37-2, 37-3, 37-4, 41-1, 41-2, 47.

At step S2-9, the reward determiner module 25 calculates a personalized reward for the identified purchaser based on the calculated CVI and CEI. In the present exemplary embodiment, the reward determiner module 25 calculates the reward from a stored lookup table comprising a grid of nine distinct, discrete discount points that are indexed by the three CVI values along one axis (horizontal), and by the three CEI values along the other axis (vertical):

| | Low | Medium | High |
|---|---|---|---|
| | Value Index | Value Index | Value Index |
| High | Discount Point 1 | Discount Point 2 | Discount Point 3 |
| Engagement | | | |
| Medium | Discount Point 4 | Discount Point 5 | Discount Point 6 |
| Engagement | | | |
| Low | Discount Point 7 | Discount Point 8 | Discount Point 9 |
| Engagement | | | |

The discount points in the table provide a scale of defined pricing discounts (percentage or fixed value) that can be dynamically selected for the initiated payment transaction, based on current and predicted purchaser value to the associated merchant and/or retail sector. It will be appreciated that the number of scaled discount points will depend on the number of discrete levels that are calculated for the CVI and CEI. Any number of discrete levels for each index is possible. The scale may consist of a sequence of distinct, discrete pricing discounts. Alternatively, the plurality of discount points can be defined by any combination of two or more distinct pricing discounts.

It will also be appreciated that although the example discussed above determines a reward from a scale of defined pricing discounts to be applied to a payment transaction (current or future), the scale of rewards can instead or in addition comprise any other form of benefit or offer, such as monetary refund, credit, or incentive, an allotment of loyalty-based points that can be accumulated and exchanged for a reward against future purchases, an offer for discounted or free goods and/or services, etc.

In the example discussed above, the attribute metrics analyzer module 43 determines and stores various transactional attribute 37-2 based on the purchaser's historical payment transaction data 35, such as a coffee shop total spend attribute indicative of the total spend by the purchaser in a defined period of time across the coffee shop retail sector, and a coffee shop frequency attribute indicative of the frequency of purchase transactions by the purchaser at merchants in the coffee shop retail sector within a defined period of time. The analytical engine 27 can classify the purchaser's level of current and/or predicted value to the coffee shop retail sector based on the historical total spend attribute stored in the purchaser data 33, and can classify the purchaser's level of current and/or predicted engagement within the coffee shop retail sector, based on the frequency attribute stored in the purchaser data 33. For example, the CVI calculator module 29 can compare the purchaser's coffee shop total spend attribute to a series of predetermined threshold values, whereby the purchaser is classified with: a low value index if the total spend over the past month is under $20, a medium value index if the total spend over the past month is between $20 and $50, and a high value index if the total spend over the past month is over $50. The CEI calculator module 31 can compare the coffee shop frequency attribute to a series of predetermined threshold values, whereby the purchaser is classified with: a low engagement index if the number of transactions at coffee shops is over the past month is under 5, a medium value index if the number of transactions at coffee shops over the past month is between 5 and 20, and a high value index if the number of transactions at coffee shops over the past month is over 20.

At step S2-11, the determined reward (pricing discount) is applied to the received transaction, for example by the payment platform 17 prior to processing of the discounted payment transaction to complete the purchase. Alternatively, details of the reward may be applied to or stored in the purchaser's data 33, and/or transmitted to the purchaser device, for future retrieval to redeem or obtain the associated benefit.

A number of advantages will be understood from the above description of the embodiments of the present invention.

In particular, the provision of the virtual loyalty rewards processing module coupled to the payment platform of the payment transaction processing system eliminates the need for purchasers and merchants to create, maintain and manage their own loyalty through a traditional loyalty card/number or points based system, and enables targeted benefits and rewards without an official loyalty program. Moreover, the virtual loyalty rewards processing module removes the need for impairment accounting that is a key facet of traditional loyalty program.

Additionally, the virtual loyalty rewards processing module enables merchants to identify the type of purchaser (e.g. “New”, “Occasional”, “Loyal”) and to classify a calculated value of the purchaser to the merchant/retail sector. In this way, merchants are able to identify and capitalize on sector loyalty. Enabling merchants to not only target purchasers based on value, but also place the right products/price to the purchasers to reach the desired result

The solution leverages an index that measures purchaser value across multiple merchants (e.g. clothing) to enable the retailer to only target purchasers based on their value or spend across the sector (e.g. high frequency low spend, low frequency/high spend). In addition to targeting these purchasers, the merchant can price dynamically (or present the right products) based on the current value of these purchasers to the business as well as a predicted value if they become ‘loyal’.

The payment transaction processing system described herein may be implemented by one or more computer systems such as computer system 1000 as shown in FIG. 4. Embodiments of the present invention may be implemented as programmable code for execution by such computer systems 1000. After reading this description, it will become apparent to a person skilled in the art how to implement the invention using other computer systems and/or computer architectures.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

Computer system 1000 also includes a user input interface 1003 connected to one or more input device(s) 1005 and a display interface 1007 connected to one or more display(s) 1009. Input devices 1005 may include, for example, a pointing device such as a mouse or touchpad, a keyboard, a touchscreen such as a resistive or capacitive touchscreen, etc. After reading this description, it will become apparent to a person skilled in the art how to implement the invention using other computer systems and/or computer architectures, for example using mobile electronic devices with integrated input and display components.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 1018 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product 1030 and loaded into computer system 1000 using removable storage drive 1014, hard disk drive 1012, or communication interface 1024, to provide some examples.

Alternative embodiments may be implemented as control logic in hardware, firmware, or software or any combination thereof.

It will be understood that embodiments of the present invention are described herein by way of example only, and that various changes and modifications may be made without departing from the scope of the invention.

For example, in the embodiment described above, the CVI and CEI are calculated for an identified purchaser and merchant/retail sector in response to a request for a loyalty-based reward. It will be appreciated that as an alternative, the analytical engine can be configured to calculate and update purchaser value and purchaser engagement indices for each stored purchaser account, across a predetermined list of merchants and/or associated retail sectors, as payment transactions using the respective purchaser account are processed by the payment platform. In this way, the reward determiner is able to retrieve a stored CVI and CEI for an identified purchaser and merchant/retail sector to process the request.

In the embodiment described above, the reward determiner is configured to retrieve the reward value from a stored lookup table. It will be appreciated that the lookup table need not be explicitly stored in a memory, and the reward value may instead be derived by a suitable computer software or hardware module that implements the logic for determining a dynamic reward value based on the calculated CVI and CEI as inputs.

Alternative embodiments may be envisaged, which nevertheless fall within the scope of the following claims.

What is claimed is:

1. A system for providing dynamic retailer rewards, the system comprising:
a database storing transaction data identifying attributes of a plurality of purchases by a purchaser at a plurality of different retailers associated with one or more predefined retail sectors;
a first index calculator configured to calculate a customer value index (CVI) for the purchaser based on at least one attribute of stored transaction data, the CVI indicative of a value of the purchaser to an identified retailer or retail sector based on the attributes of the plurality of purchases;
a second index calculator configured to calculate a customer engagement index (CEI) for the purchaser based on at least one attribute of the stored transaction data, the CEI indicative of a level of engagement by the purchaser with the identified retailer or retail sector; and
a reward determiner configured to calculate a dynamic reward for said purchaser based on the calculated CVI and CEI, the dynamic reward being redeemable by the purchaser against a purchase transaction at the identified retailer or a retailer of the retail sector.

2. The system of claim 1, further comprising a payment platform configured to process payment transactions for purchases by the purchaser, and to store details of processed payment transactions in the database.

3. The system of claim 2, wherein the purchaser is a registered user of the payment platform, and wherein the database stores data for a payment account of the registered user that is used to complete the payment transactions.

4. The system of claim 2, wherein the database further stores details of the purchaser's payment transactions with different merchants processed by one or more external third party payment issuers.

5. The system of claim 4, wherein the stored details for a payment transaction comprise data identifying one or more associated merchants, purchased products or services and value of the purchase.

6. The system of claim 2, wherein the reward determiner is configured to calculate the dynamic reward in response to the payment platform receiving data identifying a payment transaction to be processed for the purchaser.

7. The system of claim 1, wherein the reward comprises one or more of a monetary refund, credit, or incentive, an allotment of loyalty-based points to be exchanged for the reward against future purchases, or an offer for discounted or free goods or services.

8. The system of claim 2, wherein the reward comprises a monetary discount value and wherein the payment platform is configured to apply the reward to the payment transaction to be processed for the purchaser.

9. The system of claim 1, wherein the reward determiner is configured to determine the dynamic reward for the purchaser from a scale of reward values based on the calculated CVI and CEI.

10. The system of claim 1, wherein the calculated CVI is a current or predicted monetary value of the purchaser to the identified retailer or retail sector and wherein the calculated CEI is a current or predicted level of engagement by the purchaser with the identified retailer or retail sector.

11. The system of claim 1, wherein the first index calculator is further configured to calculate the CVI based on attributes of non-payment related transaction data associated with the purchaser.

12. The system of claim 1, wherein the second index calculator is further configured to calculate the CEI based on attributes of non-payment related transaction data associated with the purchaser.

13. The system of claim 1, wherein the CVI and the CEI are calculated based on one or more statistical prediction models.

14. The system of claim 1, wherein the CVI comprises one of a low value index, a medium value index, and a high value index, and wherein the CEI comprises one of a low engagement index, a medium engagement index, and a high engagement index.

15. The system of claim 14, wherein the reward determiner is configured to retrieve a dynamic reward value from a two dimensional table of reward values indexed by the calculated CVI and CEI.

16. The system of claim 14, wherein the two dimensional table of reward values comprises a plurality of distinct and discrete reward values.

17. The system of claim 1, further comprising an analyzer configured to analyze the stored transaction data to determine attributes of a plurality of past purchases by a purchaser at a respective plurality of different retailers

18. The system of claim 17, wherein the analyzer is configured to determine one or more of demographic attributes, transactional attributes, behavioral attributes, or attrition attributes.

19. The system of claim 17, wherein the transactional attributes comprise a total spend attribute and a frequency attribute for a plurality of payment transactions by the purchaser in a defined period of time at the identified retailer or retail sector.

20. The system of claim 17, wherein the analyzer is configured to determine a disloyalty attribute indicative of a potential value of moving a purchaser's projected expenditure to one or more of a merchant's competitors.

21. A computer-implemented method performed by one or more processors for determining a dynamic reward for a purchaser, the method comprising steps of:
storing transaction data identifying attributes of a plurality of purchases by a purchaser at a plurality of different retailers associated with one or more predefined retail sectors;
calculating a customer value index (CVI) for the purchaser based on at least one attribute of the stored transaction data, the CVI indicative of a value of the purchaser to an identified retailer or retail sector based on the attributes of the plurality of purchases;
calculating a customer engagement index (CEI) for the purchaser based on at least one attribute of the stored transaction data, the CEI indicative of a level of engagement by the purchaser with the identified retailer or retail sector; and
determining the dynamic reward for the purchaser based on the calculated CVI and CEI, the dynamic reward being redeemable by the purchaser against a purchase transaction at the identified retailer or retail sector.
